(19) United States
(12) Patent Application Publication
(10) Pub. No.: US 2020/0154678 A1
(43) Pub. Date: May 21, 2020

(54) Multi-Function Pet Leash Attachment

(71) Applicant: Timothy Harrison, Royal Oak, MI (US)

(72) Inventor: Timothy Harrison, Royal Oak, MI (US)

(21) Appl. No.: 16/194,966

(22) Filed: Nov. 19, 2018

(51) Int. Cl. A01K 27/00

(52) U.S. Cl. CPC A01K 27/008; E01H 2001/1273; A01K 27/006

(57) ABSTRACT

A pet leash attachment comprising a housing attachable to a leash. The housing has a first end, a second end opposing the first end, and at least one side wall extending between the first end and the second end. A first cavity within the housing is configured to store a roll of pet waste bags. An opening extends through the at least one side wall of the housing into the first cavity. A slit extends through the at least one side wall of the housing from the second end. The opening and the slit are radially spaced a distance from one another.

### TECHNICAL FIELD

This disclosure relates generally to pet leash attachments, and more particularly, to multi-function pet leash attachments that provide light, store unused waste bags, and hold a soiled waste bag a distance from the owner.

### BACKGROUND

While enjoying a walk or run with their pet, responsible pet owners are often tasked with dealing with soiled waste bags from cleaning up after their pet. Typically, the pet owner carries the soiled waste bag(s) in his or her hand until he or she returns home, which can be considerable time and/or distance. This task is unpleasant and can take the enjoyment out of the walk or run for the pet owner because of the associated odors and the awkwardness of holding the leash and the bag of waste.

### SUMMARY

Multi-function pet leash attachments are disclosed herein. According to one embodiment, a pet leash attachment comprising a housing attachable to a leash. The housing has a first end, a second end opposing the first end, and at least one side wall extending between the first end and the second end. A first cavity within the housing is configured to store a roll of pet waste bags. An opening extends through the at least one side wall of the housing into the first cavity. A slit extends through the at least one side wall of the housing from the second end, and the opening and the slit are radially spaced a distance from one another.

The pet leash attachment can have a light at or on the first end of the housing. The slit can be comprised of a first section adjacent to the second end of the housing and a second section spaced away from the second end of the housing. The first section of the slit can be in communication with the second section of the slit, and the first section of the slit can have a different configuration than the second section of the slit. The first section of the slit can have a V-shaped or triangular configuration, and sides of the second section can be generally parallel to one another. The opening and the slit are not radially aligned. The opening and the slit can be generally perpendicular to one another. The housing can have a tubular and/or cylindrical configuration. Sides of the slit can have a serrated or wave configuration.

The pet leash attachment can include a second cavity in housing that the slit opens into. A wall can separate the cavity from the second cavity. The cavity can be in communication with a first bore in the first end of the housing, and the second cavity can be in communication with a second bore in the second end of the housing. A removeable or openable cap can partially cover the second bore, and a removeable or openable cap with a light can partially cover the first bore. The pet leash attachment can also include a first strap and a second strap that are configured to secure the housing to a leash. The second strap can be positioned between the slit and the wall, and the first strap can be positioned closer to the first end of the housing than the second strap.

In another embodiment, a pet leash attachment comprises a tubular housing attachable to a leash. The tubular housing has a first end, a second end opposing the first end, and a cylindrical side wall extending longitudinally between the first end and the second end. A first cavity within the tubular housing is configured to store a roll of pet waste bags. The first cavity is in communication with a first opening on the first end of the tubular housing. A cap with a light at least partially covers the first opening of the tubular housing. An opening extends through the cylindrical side wall of the tubular housing into the first cavity. A slit extends through the cylindrical side wall of the housing from the second end. The opening and the slit are radially spaced a distance from one another and are not aligned.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of a pet owner walking a dog on a leash with a leash attachment holding soiled waste bags.

FIG. 2 is a side plan view of the leash attachment.

FIG. 3 is a bottom plan view of the leash attachment.

FIG. 4 is an exposed cross-sectional side plan view of a housing of the leash attachment.

FIG. 5 is a schematic drawing showing radial spacing of an opening in the housing in relation to a slit in the housing.

FIG. 6 is a schematic drawing of an alternative embodiment of the slit in the housing.

FIG. 7 is a schematic drawing of another alternative embodiment of the slit in the housing.

FIG. 8 is a bottom plan view of an end of the leash attachment with an end cap.

FIG. 9 is a schematic drawing of an alternative embodiment of a means to attach the leash attachment to the leash.

### DETAILED DESCRIPTION

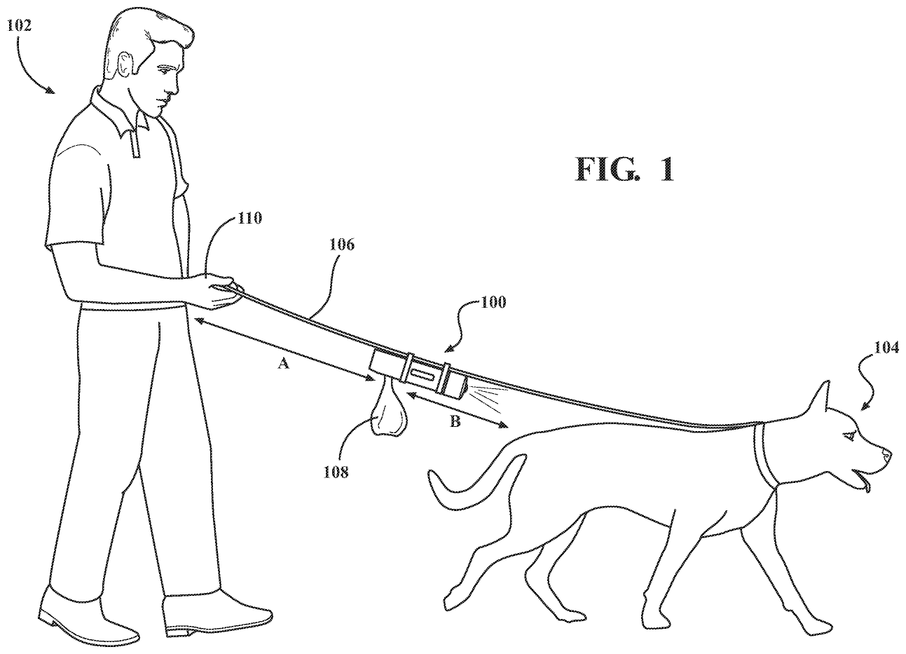

FIG. 1 illustrates a pet owner 102 walking a dog 104 on a leash 106. A leash attachment 100 is attached to the leash 106. In the illustrated example, the dog 104 has defecated while the pet owner 102 was out on a walk with the dog 104. The pet owner 102 cleaned up after the dog 104 and has a soiled waste bag 108 to contend with on the remainder of the walk. Instead of carrying the soiled waste bag 108 in his hand 110, the soiled waste bag 108 is secured to the leash attachment 100 a distance A from the pet owner 102 and a distance B from the dog 104. This minimizes the associated odors that the pet owner 102 smells and relieves the pet owner 102 from having to carry the soiled waste bag 108, while also minimizing the likelihood that the dog 104 comes into contact with the contents of the soiled waste bag 108.

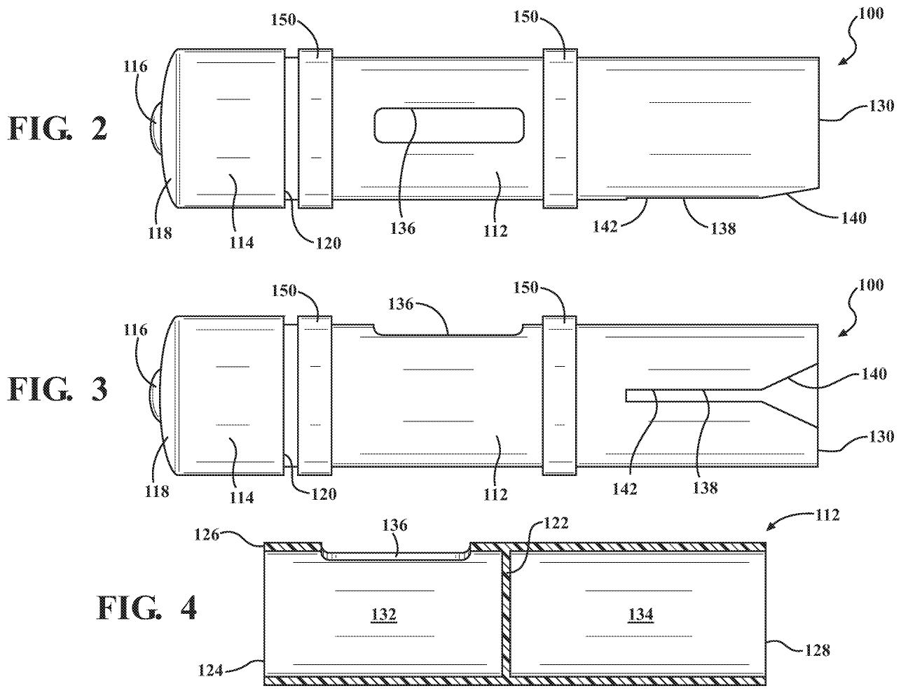

The leash attachment 100 can be comprised of a housing 112 and a first end cap 114, as shown in FIGS. 2-4. An LED 116 can be included on a first end 118 of the first end cap 114. The LED 116 can be turned on by any means known in the art. For example, a bi-directional switch on a side of the first end cap 114 could be used. Alternatively, a detent (not shown) could be positioned under LED 116 so that the LED 116 can be turned on and off by pressing the LED 116 toward a second end 120 of the first end cap 114.

The housing 112 can have a substantially tubular and/or cylindrical configuration with a first opening 124 or bore in a first end 126 and a second opening 128 or bore in a second end 130. The first end cap 114 can be removably and/or detachably connected to the first end 126 of the housing 112 to partially or substantially cover the first opening 124. In the illustrated, non-limiting example, the first end cap 114 is sized so that the first end cap 114 can be connected to the first end 126 of the housing 112 using an interference or friction fit. Other alternatives are possible. For example, a hinge or similar type of mechanism could be used to connect the first end cap 114 to the housing 112. In some embodiments, the first end cap 114 could be omitted entirely.

An inner separation wall 122 can be disposed approximately halfway between the first end 126 and the second end 130 of the housing 112. The inner separation wall 122 can be integrally formed with the housing 112 or formed from separate piece attached to the housing 112. In some embodiments, the inner separation wall 122 is substantially solid, and in other embodiments, the inner separation wall 112 has voids or apertures that help reduce the overall weight of the leash attachment 100. The inner separation wall 122 divides the interior of the housing 112 into a first cavity 132 and a second cavity 134. The first cavity 132 is in communication with the first opening 124 in the first end 126 of the housing 112, and the second cavity 134 is in communication with the second opening 128 in the second end 130 of the housing 112. The first opening 124 and the first cavity 132 are sized to accept a roll of pet waste bags (not shown).

A third opening 136 can be provided on a circumferential side wall of the housing 112. The third opening 136 can be in communication with the first cavity 132 so that a bag (not shown) from the roll of pet waste bags can be obtained. As a result, the third opening 136 is longitudinally closer to the first end 126 of the housing 112 than the second end 130 of the housing 112. In the illustrated, non-limiting example, the third opening 136 has a substantially rectangular configuration. However, other configurations are possible. For example, the third opening 136 could have an oval configuration.

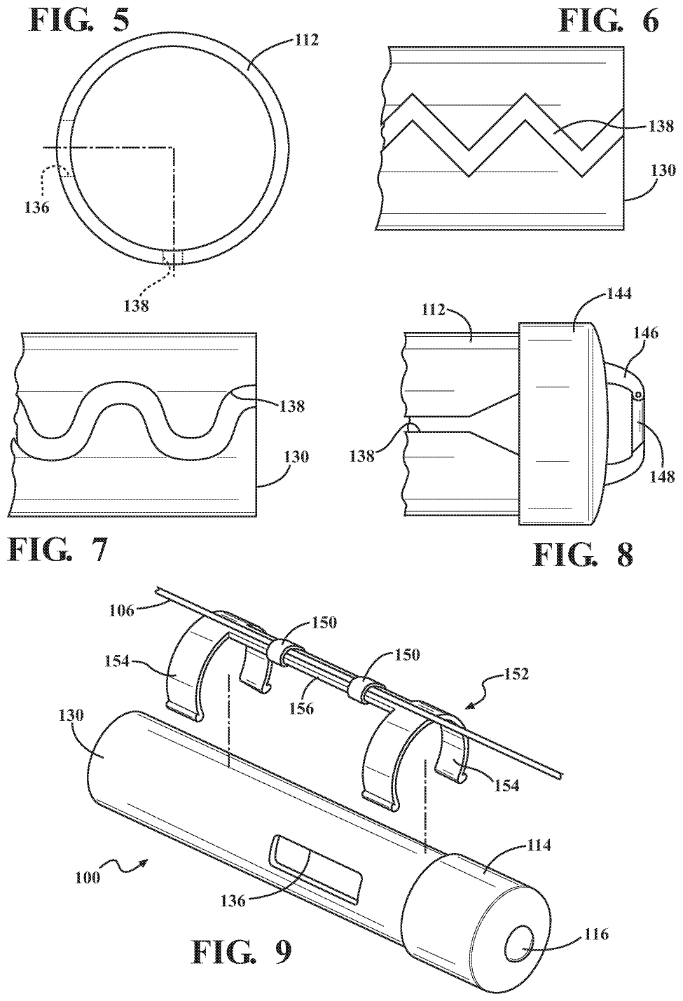

To allow the leash attachment 100 to hold the soiled waste bags 108, a slit 138 or track is provided on the housing 112. The slit 138 is in communication with the second opening 128 and the second cavity 134. As a result, the slit 138 is longitudinally closer to the second end 130 of the housing 112 than the first end 126 of the housing 112. The slit 138 can be radially displaced from the third opening 136 so that the slit 138 and the third opening 136 are not radially aligned. In the illustrated, non-limiting example, the slit 138 is radially spaced approximately 90-degrees from the third opening 136, which can be further understood with reference to FIG. 5.

The configuration of the slit 138 can vary depending on the implementation. As shown in FIGS. 2-3, the slit 138 has a first section 140 with a V-shaped or triangular configuration and a second section 142 with a substantially linear configuration. The first section 140 is adjacent to the second end 130 of the housing 112, and the second section 142 is positioned between the inner separation wall 122 and the first section 140 of the slit 138. In the implementation shown in FIG. 6, the slit 138 has a serrated configuration. In the implementation shown in FIG. 7, the slit 138 has a wave configuration.

FIG. 8 shows an alternative implementation that includes a second end cap 144 on the second end 130 of the housing 112 adjacent to the slit 138. Like the first end cap 114, the second end cap 144 can be removably and/or detachably connected to the second end 130 of the housing 112 to partially or substantially cover the second opening 128. In the illustrated, non-limiting example, the second end cap 144 is sized so that the second end cap 144 can be connected to the second end 130 of the housing 112 using an interference or friction fit. Other alternatives are possible. For example, a hinge or similar type of mechanism could be used to connect the second end cap 144 to the housing 112.

In additional to covering the second opening 128, the second end cap 144 can be used as a security attachment to the leash attachment 100. For example, the second end cap 144 could be provided with a Global Positioning System (GPS) tracker (not shown) that assists with quickly locating the pet owner 102 and the dog 104 if the need arises. The second end cap 144 could also be provided with a means to attach and easily access a personal self-defense spray (not shown). As shown, the second end cap 144 is provided with a loop 146 and a spring-loaded gate 148 to attach the personal self-defense spray. Other types of connectors could be used, and the GPS tracker and attachment means could be provided elsewhere in the leash attachment.

To secure the leash attachment 100 to the leash 106, the leash attachment 100 is provided with two connectors. The connectors can be any means known in the art. In the illustrated, non-limiting example, the connectors are two hook and latch straps 150. One of the hook and latch straps 150 is positioned adjacent to the first end 126 of the housing 112 between the first end cap 114 and the third opening 136. The other hook and latch strap 150 can be positioned between the third opening 136 and the slit 138.

In alternative embodiment, the leash attachment 100 includes a sled 152 with C-clips 154 and a connecting member 156. As shown, there are two C-clips 154 that are configured to be complementary to the housing 112 so that the housing 112 can be “snapped” into and held by the C-clips 154 via an interference or friction fit. The connecting member 156 can have a generally elongated configuration with one of the C-clips 154 on each end. In the illustrated, non-limiting example, the connecting member 156 extends generally parallel with the leash 106, so that the hook and latch straps 150 can secure the sled 152 to the leash 106.

Once attached to the leash 106 or another object, such as a stroller, the leash attachment 100 is slid into position so that the leash attachment 100 is the distance A from the pet owner 102 and the distance B from the dog 104. As needed, the pet owner 102 can activate the LED 116 to provide light and obtain waste bags through the third opening 136. The pet owner 102 can also use the leash attachment to carry soiled waste bags 108 by tying ends (not shown) of the soiled waste bag 108 into a knot and inserting the knot into the second opening 128 of the housing 112 and/or the first section 140 of the slit 138. The knot is then slid along the slit 138 a distance away from the second end 130 of the housing 112 toward the inner separation wall 122. The leash attachment 100 can hold multiple soiled waste bags 108 by repeating the same steps. Once the pet owner 102 has completed his or her walk or has found a location where he or she can dispose of the soiled waste bags 108, the soiled waste bags 108 are removed from the leash attachment 100 by sliding the knot out of the slit 138 toward the second opening 128 of the housing 112. If the leash attachment 100 is provided with the second end cap 144, the second end cap 144 is removed or opened each time the pet owner 102 needs to access the second opening 128 to add or remove the soiled waste bags 108.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A pet leash attachment comprising:
a housing attachable to a leash, the housing having a first end, a second end opposing the first end, and at least one side wall extending between the first end and the second end;
a first cavity within the housing configured to store a roll of pet waste bags;
an opening extending through the at least one side wall of the housing into the first cavity; and
a slit extending through the at least one side wall of the housing from the second end, wherein the opening and the slit are radially spaced a distance from one another.

2. The pet leash attachment of claim 1, further comprising:
a light at or on the first end of the housing.

3. The pet leash attachment of claim 1, wherein the slit is comprised of a first section adjacent to the second end of the housing and a second section spaced away from the second end of the housing, wherein the first section of the slit is in communication with the second section of the slit, and wherein the first section of the slit has a different configuration than the second section of the slit.

4. The pet leash attachment of claim 3, wherein the first section of the slit has a V-shaped or triangular configuration.

5. The pet leash attachment of claim 4, wherein sides of the second section of the slit are generally parallel to one another.

6. The pet leash attachment of claim 1, wherein the opening and the slit are not radially aligned.

7. The pet leash attachment of claim 1, wherein the opening and the slit are generally perpendicular to one another.

8. The pet leash attachment of claim 1, wherein the housing has a tubular configuration.

9. The pet leash attachment of claim 1, wherein the housing has a cylindrical configuration.

10. The pet leash attachment of claim 1, wherein sides of the slit have a serrated configuration.

11. The pet leash attachment of claim 1, wherein sides of the slit have wave configuration.

12. The pet leash attachment of claim 1, further comprising:
a second cavity in the housing, wherein the slit opens into the second cavity.

13. The pet leash attachment of claim 12, wherein a wall separates the first cavity from the second cavity.

14. The pet leash attachment of claim 13, wherein the first cavity is in communication a first bore in the first end of the housing, and wherein the second cavity is in communication with a second bore in the second end of the housing.

15. The pet leash attachment of claim 14, wherein a removeable or openable cap at least partially covers the second bore.

16. The pet leash attachment of claim 15, wherein a removable or openable cap with a light at least partially covers the first bore.

17. The pet leash attachment of claim 16, further comprising:
a first strap; and
a second strap, wherein the first strap and the second strap are configured to secure the housing to a leash.

18. The pet leash attachment of claim 17, wherein the second strap is positioned between the slit and the wall.

19. The pet leash attachment of claim 18, wherein the first strap is positioned closer to the first end of the housing than the second strap.

20. A pet leash attachment comprising:
a tubular housing attachable to a leash, the tubular housing having a first end, a second end opposing the first end, and a cylindrical side wall extending longitudinally between the first end and the second end;
a first cavity within the tubular housing configured to store a roll of pet waste bags, wherein the first cavity is in communication with a first opening on the first end of the tubular housing;
a cap with a light at least partially covering the first opening of the tubular housing;
an opening extending through the cylindrical side wall of the tubular housing into the first cavity; and
a slit extending through the cylindrical side wall of the tubular housing from the second end, wherein the opening and the slit are radially spaced a distance from one another and are not aligned.
